(19) United States
(12) Patent Application Publication
(10) Pub. No.: US 2008/0303200 A1
(43) Pub. Date: Dec. 11, 2008

(54) IMAGE FORMING SYSTEM

(76) Inventor: Takehiro OGUSHI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/098,843

(22) Filed: Apr. 7, 2008

(30) Foreign Application Priority Data
Jun. 6, 2007 (JP) JP2007-150232

(51) Int. Cl. B41F 13/00; B65H 43/04

(52) U.S. Cl. 270/1.01; 270/52.04

(57) ABSTRACT

In an image forming system including an intermediate conveyance apparatus capable of superimposing plural sheets conveyed from an image forming apparatus, and of conveying the superimposed sheets to a sheet finisher as a set, a controller causes a conveyance interval for sheets in the image forming apparatus to be the first conveyance interval, then, superimposes plural sheets in the intermediate conveyance apparatus, and conveys superimposed sheets to the sheet finisher as a set, when characteristic information of sheets to be conveyed continuously agrees with a prescribed condition. The controller causes a conveyance interval for sheets to be the second conveyance interval greater than the first conveyance interval, and conveys sheets from the intermediate conveyance apparatus to the sheet finisher, without superimposing sheets in the intermediate conveyance apparatus, when the characteristic information of sheets to be conveyed continuously does not agree with the prescribed condition.

This application is based on Japanese Patent Application No. 2007-150232 filed on Jun. 6, 2007, which is incorporated hereinto by reference.

### BACKGROUND OF THE INVENTION

The present invention relates to an image forming system having an intermediate conveyance apparatus wherein plural sheets conveyed from an image forming apparatus are superimposed, and these superimposed sheets can be conveyed to a sheet finisher as one set.

There has been known an image forming system wherein a sheet finisher is connected to an image forming apparatus such as a copying machine and a printer, and binding processing is conducted for sheets on which images are formed by an image forming apparatus and a punching processing for filing is conducted. In recent years, since the image forming system of this kind has been used in a short-run printing field, high productivity (fast output) in image forming system, in particular, is demanded by users.

To secure high productivity in an image forming system, it is necessary to convey sheet continuously from an image forming apparatus to a sheet finisher without stopping image forming actions in the image forming apparatus, even in the course of conducting post processing such as binding processing in a sheet finisher.

It is therefore suggested a technology to provide in a sheet finisher a section to superimpose a plurality of sheets conveyed from an image forming apparatus, the technology being the same as those described in Unexamined Japanese Patent Application Publication No. 2001-158564 and Unexamined Japanese Patent Application Publication No. 2004-277094. In this technology, a sheet conveyed from an image forming apparatus is stopped temporarily on a conveyance path, and a preceding sheet can be post-processed while the succeeding sheet is stopped, thus, it is not necessary to stop image forming operations in the image forming apparatus even in the midst of the post-processing such as binding processing conducted by a sheet finisher.

Further, it is also possible to think of an image forming system wherein an intermediate conveyance apparatus is provided between an image forming apparatus and a sheet finisher, considering a sheet finisher having no section for superimposing plural sheets, and plural sheets conveyed are superimposed in the intermediate conveyance apparatus. Even in the case of the image forming system employing the intermediate conveyance apparatus, it is not necessary to stop the image forming operations in the image forming apparatus in the midst of the post-processing such as binding processing in the sheet finisher, thus, high productivity in the image forming system can be secured.

Meanwhile, in the image forming system wherein an intermediate conveyance apparatus is provided between an image forming apparatus and a sheet finisher, and plural sheets conveyed are superimposed in the intermediate conveyance apparatus, there is a fixed distance for conveyance covering from the intermediate conveyance apparatus to the sheet finisher. Therefore, when this image forming system is compared with one having, in a sheet finisher, a section to superimpose plural sheets, a distance for conveyance under the state of superimposed plural sheets in this image forming system is longer.

If characteristics such as a size and a type are the same between superimposed sheets, no displacement between sheets is caused, even if the distance for conveyance under the state of superimposed plural sheets is long. However, if characteristics such as a size and a type are different between superimposed sheets, displacement between sheets tends to be caused, if the distance for conveyance under the state of superimposed plural sheets becomes long.

Once the displacement is caused undesirably, no positional adjustment is made between sheets, and there are feared problems such as occurrence of troubles in post-processing including punching processing and binding processing and occurrence of paper jam in an intermediate conveyance apparatus and in a sheet finisher.

### SUMMARY OF THE INVENTION

An image forming system relating to the invention is one having therein an image forming apparatus that forms an image on a sheet, a sheet finisher that conducts post-processing for a sheet conveyed from the image forming apparatus and an intermediate conveyance apparatus capable of superimposing plural sheets conveyed from the image forming apparatus, and of conveying the superimposed sheets to the sheet finisher as a set, wherein a controller that controls operations to convey sheets and operations to superimpose sheets is provided, and the controller causes a conveyance interval for sheets in the image forming apparatus to be the first conveyance interval, then, superimposes plural sheets in the intermediate conveyance apparatus, and conveys superimposed sheets from the intermediate conveyance apparatus to the sheet finisher as a set, when characteristic information of sheets to be conveyed continuously agrees with the prescribed condition, and the controller causes a conveyance interval for sheets in the image forming apparatus to be the second conveyance interval that is greater than the first conveyance interval, and conveys sheets from the intermediate conveyance apparatus to the sheet finisher, without superimposing sheets in the intermediate conveyance apparatus, when characteristic information of sheets to be conveyed continuously does not agree with the aforesaid prescribed condition.

### BRIEF DESCRIPTION OF THE DRAWINGS

FIG. 1 is an overall structural diagram of an image forming system having therein an image forming apparatus, an intermediate conveyance apparatus and a sheet finisher.

FIG. 2 is a block diagram of a control system in the image forming system.

FIG. 3 is a front sectional view of the intermediate conveyance apparatus.

FIG. 4 is a sectional view showing a driving device near intermediate storing section 12 of the intermediate conveyance apparatus.

FIG. 5 is a sectional view showing a driving device for a sideward alignment plate.

Each of FIGS. 6(a)-6(d) is an illustration diagram showing a process of superimposing sheets in the intermediate conveyance apparatus.

Each of FIGS. 7(a)-7(d) is an illustration diagram showing a process of superimposing sheets in the intermediate conveyance apparatus.

FIG. 8 is a flow chart concerning control of operations for superimposing in the intermediate conveyance apparatus and of operations of sheet conveyance in the image forming apparatus.

FIG. 9 is a flow chart showing judgment operations for whether or not plural sheets are superimposed in the intermediate conveyance apparatus.

### DETAILED DESCRIPTION OF THE PREFERRED EMBODIMENT

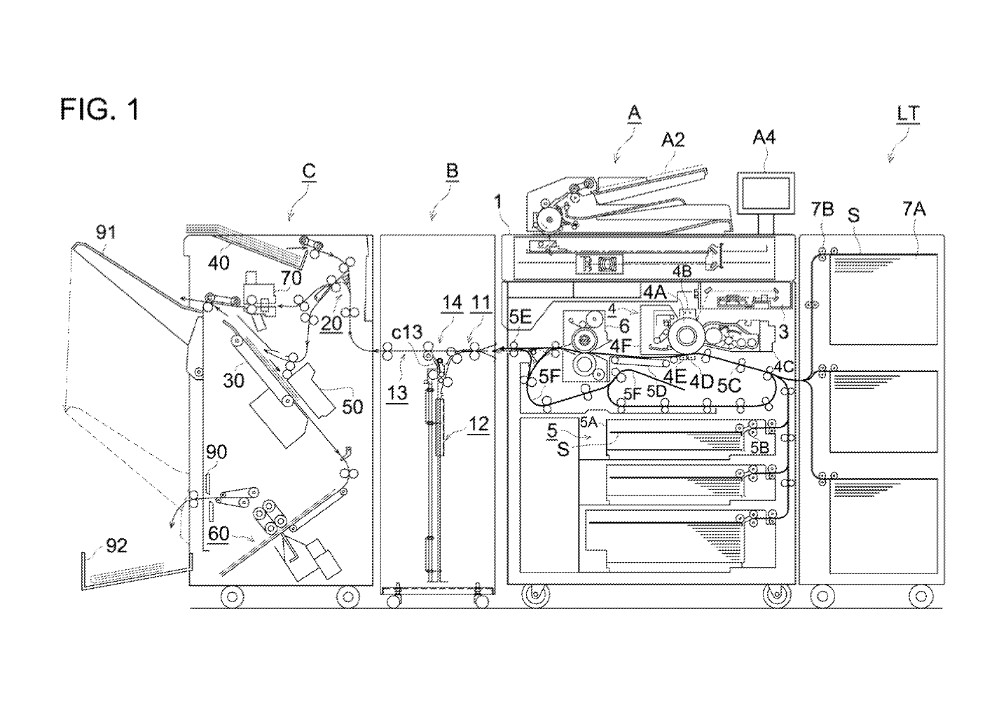

FIG. 1 is an overall structural diagram of an image forming system having therein image forming apparatus A, intermediate conveyance apparatus B and sheet finisher C.

The image forming apparatus A is equipped with image reading section 1, image writing section 3, image forming section 4, sheet conveyance section 5, fixing section 6, automatic document conveyance section A2 and with operation and display section A4.

The image forming section 4 is composed of photoreceptor drum 4A, charger 4B, developing unit 4C, transfer unit 4D, separation unit 4E and of cleaning unit 4F.

The sheet conveyance section 5 is equipped with sheet cassette 5A, first sheet feed unit 5B, second sheet feed unit 5C, conveyance unit 5D, ejection unit 5E and with reverse and conveyance unit 5F.

The operation and display section A4 is equipped with a touch panel wherein a touch screen is arranged to be superimposed on a display section composed of a liquid crystal panel. Various types of operation screens can be displayed on the operation and display section A4, and post-processing types and types of sheets to be stored in the sheet cassette 5A can be established on the operation and display section A4.

A document placed on a document platen of the automatic document conveyance section A2 is read by an optical system of the image reading section 1, while, analog signals resulting from photoelectric transduction are transmitted to the image writing section 3 after they are subjected to processing such as analog processing in image processing section 2, A/D conversion, shading correction and image compression processing.

In the image writing section 3, photoreceptor drum 4A of the image forming section 4 is irradiated with a beam emitted from a semiconductor laser, and a latent image is formed on the photoreceptor drum 4A. Further, in the image forming section 4, there are conducted processing operations of charging, exposure, developing, transfer, separation and cleaning.

A toner image formed on the photoreceptor drum 4A is transferred onto sheet S by the transfer unit 4D. The sheet S onto which the toner image is transferred is fixed by the fixing section 6, and is conveyed to intermediate conveyance apparatus B from sheet ejection section 5E. When forming images on both sides of the sheet S, the sheet S is conveyed to reverse and conveyance unit 5F, and an image is formed again on the reverse side of the sheet S in the image forming section 4.

Incidentally, image forming apparatus A in the present embodiment is one to form a monochromatic image on sheet S through an electro-photographic system, but an image forming apparatus relating to the invention may also be a color image forming apparatus naturally without being limited to the present embodiment, and its image forming method may be anything other than the electro-photographic system such as an ink-jet process, a thermal dye transfer method, a silver halide photography method and an electro-photographic method.

Large capacity sheet feed device LT is composed of sheet stacking section 7A and first sheet feeding unit 7B, and it feeds sheet S into image forming apparatus A continuously.

Intermediate conveyance apparatus B installed between image forming apparatus A and sheet finisher C can superimpose plural sheets S conveyed from the image forming apparatus A, and can convey superimposed sheets S to the sheet finisher C as one set. If plural sheets S conveyed respectively from the image forming apparatus A are stopped temporarily at the intermediate conveyance apparatus B to be superimposed, preceding post-processing such as binding processing for sheets S can be conducted in the sheet finisher C while the aforesaid plural sheets S are superimposed. Therefore, it is not necessary to stop image forming operations in the image forming apparatus A even in the midst of conducting the post-processing in the sheet finisher C.

When the intermediate conveyance apparatus B is installed between the image forming apparatus A and the sheet finisher C as shown FIG. 1, it is possible to combine image forming apparatus A having high speed of operations, for example, and sheet finisher C having low speed operations. Detailed explanation of the intermediate conveyance apparatus B will be given later.

The sheet finisher C conducts post-processing such as punching processing and binding processing on the sheet conveyed from the intermediate conveyance apparatus B. In the sheet finisher C, there are provided insert sheet feed section 40 storing therein inserting sheets (to be used for a cover sheet and a rear cover sheet), stacking section 30, binding processing section 50, folding section 60 and punching processing section 70. Further, in the vicinity of the folding section 60, there is provided cutting section 90 that cuts edges of a center-bound booklet. Incidentally, though there is provided cutting section 90 on sheet finisher C in the present embodiment, it is also possible to arrange so that a booklet may be cut by using a general-purpose paper cutter separately after the booklet is ejected from the sheet finisher C.

On the left side of the sheet finisher C illustrated, there are arranged movable ejection tray 91 that conducts no post-processing and ejects printed sheets as they are to stack them and fixed ejection tray 92 on which a center-bound booklet is stacked.

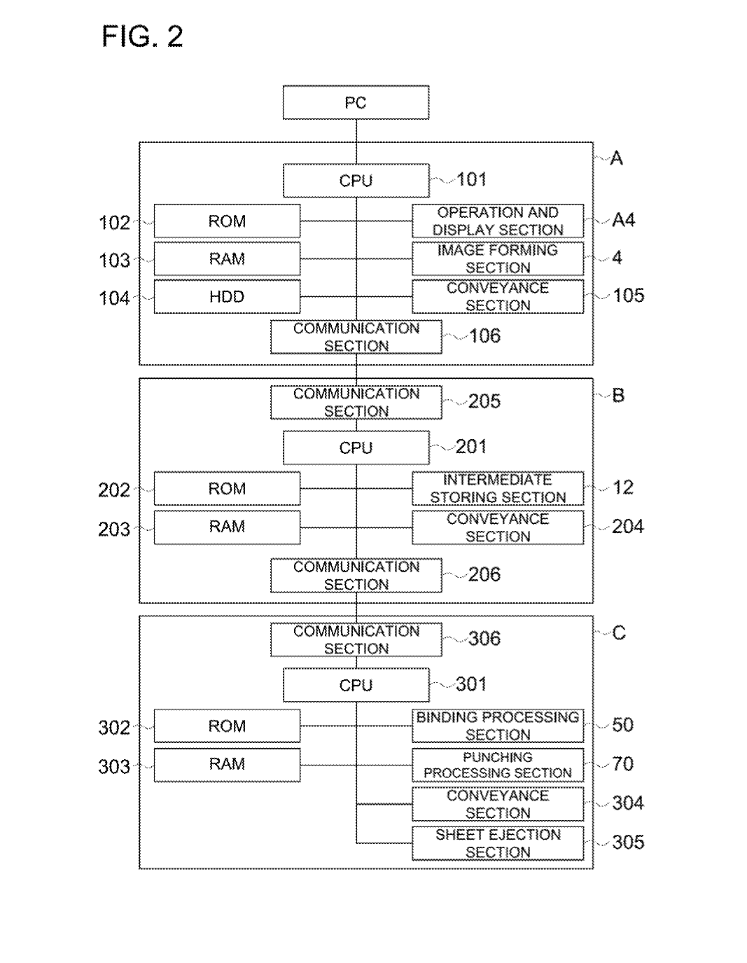

FIG. 2 is a block diagram of a control system in the image forming system, and a typical structure is shown in FIG. 2.

CPU (Central Processing Unit) 101 is one to control operations of image forming apparatus A, and it is connected to ROM (Read Only Memory) 102 and RAM (Random Access Memory) 103 through a system bus. The CPU 101 reads out various types of control programs stored in ROM 102, and develops them on RAM 103 to control operations of each section in the image forming system. Further, CPU 101 conducts various types of processing in accordance with programs developed on RAM 103, then, stores results of the processing in RAM 103 and causes operation and display section A4 to display them. Then, CPU 101 causes prescribed destinations to save to store the results of the processing stored in RAM 103.

ROM 102 stores programs and data, and it is typically composed of semiconductor memories.

RAM 103 forms a work area that stores temporarily data processed by various types of control programs conducted by CPU 101.

HDD 104 stores image data of document images obtained by reading image reading section 1, and stores outputted image data.

Each of intermediate conveyance apparatus B and sheet finisher C has respectively CPUs 201 and 301, ROMs 202 and 302 and RAMs 203 and 303 in the same way as in image forming apparatus A. CPU 201 in the intermediate conveyance apparatus B controls operations of the intermediate conveyance apparatus B in cooperation with ROM 202 and RAM 203, and CPU 301 in the sheet finisher C controls operations of the sheet finisher C in cooperation with ROM 302 and RAM 303.

The image forming apparatus A, the intermediate conveyance apparatus B and the sheet finisher C are connected respectively through communication sections 106, 205, 206 and 306, and delivery and receipt of information and signals are conducted between respective apparatuses.

In the present embodiment, CPU 101 and CPU 201 work together in cooperation with ROMs 102 and 202 and with RAMs 103 and 203 to constitute a control section.

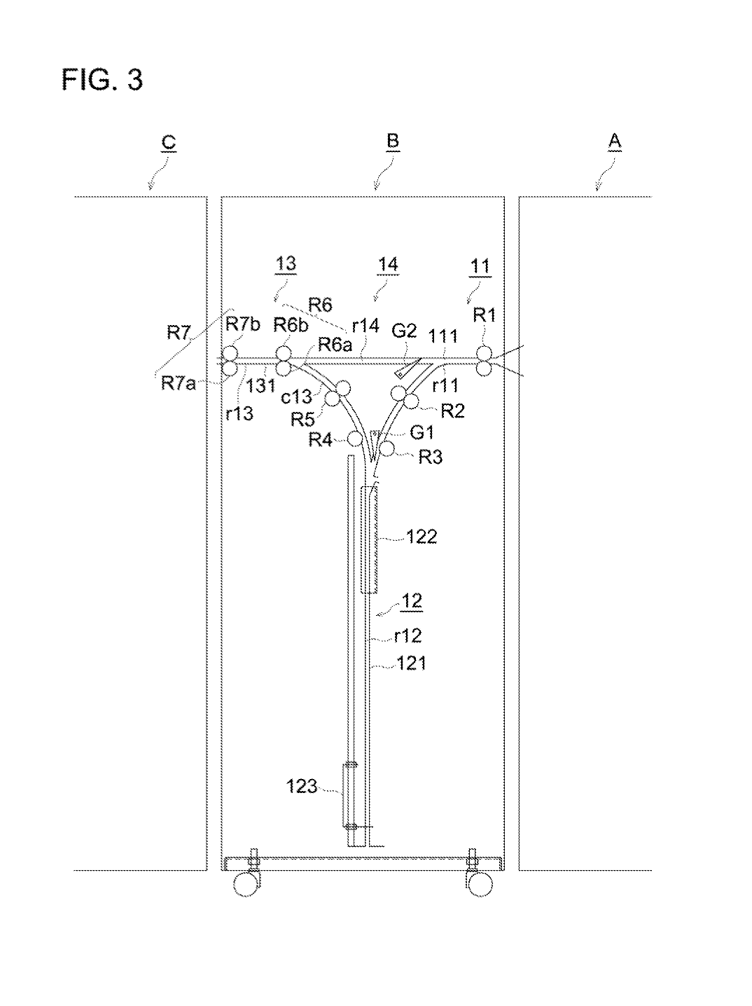

FIG. 3 is a front sectional view of intermediate conveyance apparatus B.

The intermediate conveyance apparatus B is composed of sheet bring-in section 11, intermediate storing section 12, sheet take-out section 13 and bypass conveyance section 14.

The sheet bring-in section 11 is equipped with sheet conveyance path r11 that has therein conveyance rollers R1, conveyance rollers R2 and guide plate 111. In the sheet bring-in section 11, sheets S ejected from sheet ejection section 5E of image forming apparatus A are received one after another and are conveyed.

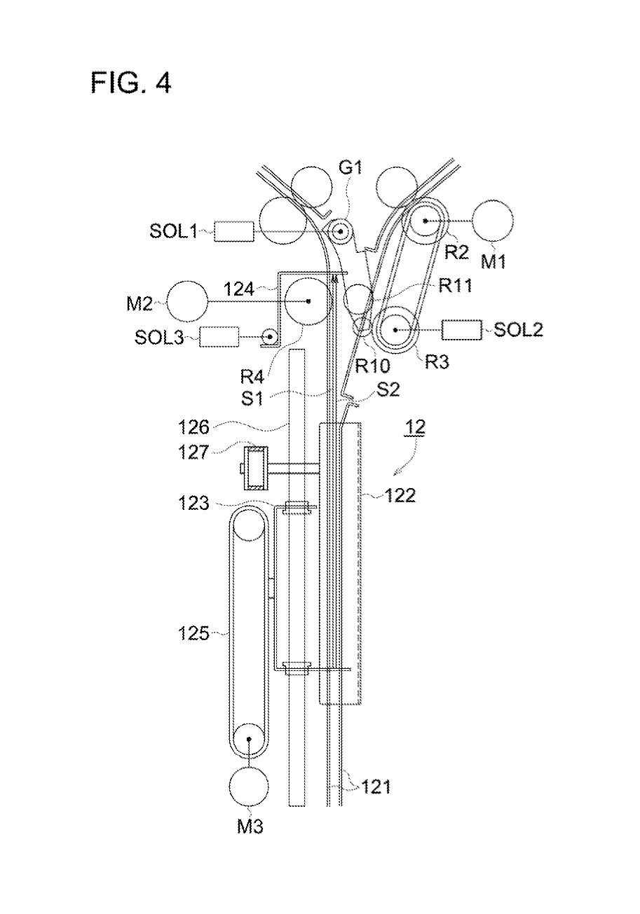

Intermediate storing section 12 is equipped with a longitudinal aligning section having therein two guide plates 121 arranged to be in parallel, sideward aligning section 122, stopping member 123 and longitudinal aligning member 124 (refer to FIG. 4), bring-in drive roller R3, take-out drive roller R4 and with sheet conveyance path r12. In the intermediate storing section 12, plural sheets S received from sheet bring-in section 11 are superimposed, and then, are ejected upward.

Sheet take-out section 13 is equipped with intermediate conveyance roller R5, paired sheet ejection rollers R6 (R6a and R6b) and paired sheet ejection rollers R7 (R7a and R7b), sheet conveyance path r13 having guide plate 131 and with curved conveyance section c13. In the sheet take-out section 13, plural sheets S stored in intermediate storing section 12 are reversed and conveyed under the condition that they are superimposed, to be fed into sheet finisher C.

Bypass conveyance section 14 is equipped with sheet conveyance path r14. Conveyance of a sheet to the bypass conveyance section 14 is conducted when it is not necessary to convey to the intermediate storing section 12. For example, conveyance of a sheet to the bypass conveyance section 14 is conducted when post-processing such as binding processing on sheet S is not needed in the sheet finisher C.

Conveyance path switching section G2 is one to switch a conveyance path through which sheet S passes, and it guides sheet S to bypass conveyance path 14 or to intermediate storing section 12. On the upper portion of the intermediate storing section 12, there is provided conveyance path switching section G1 that switches between introduction of sheet S to intermediate storing section 12 and ejection of sheet S from the intermediate storing section 12. Conveyance path switching sections G1 and G2 are connected respectively to a solenoid to be driven.

FIG. 4 is a sectional view showing a driving device near intermediate storing section 12 of intermediate conveyance apparatus B.

Conveyance path switching section G1 that supports bring-in driven roller R10 and take-out driven roller R11 is driven by solenoid SOL1 to swing. Bring-in drive roller R3 is driven by solenoid SOL2 to open and close sheet conveyance path r11. Longitudinal aligning member 124 is driven by solenoid SOL3 to swing.

Motor M1 rotates conveyance roller R2 and rotates bring-in drive roller R3 through a belt. Motor M2 rotates take-out drive roller R4.

Stopping member 123 is engaged with belt 125 rotated by motor M3, and is guided by guide bar 126 to move up and down.

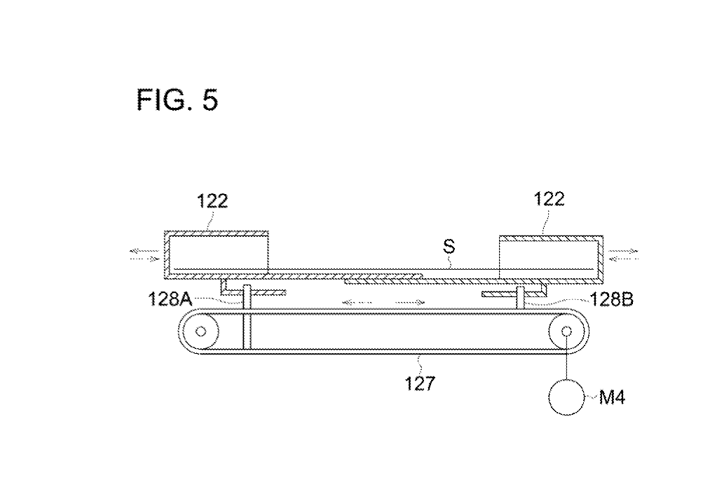

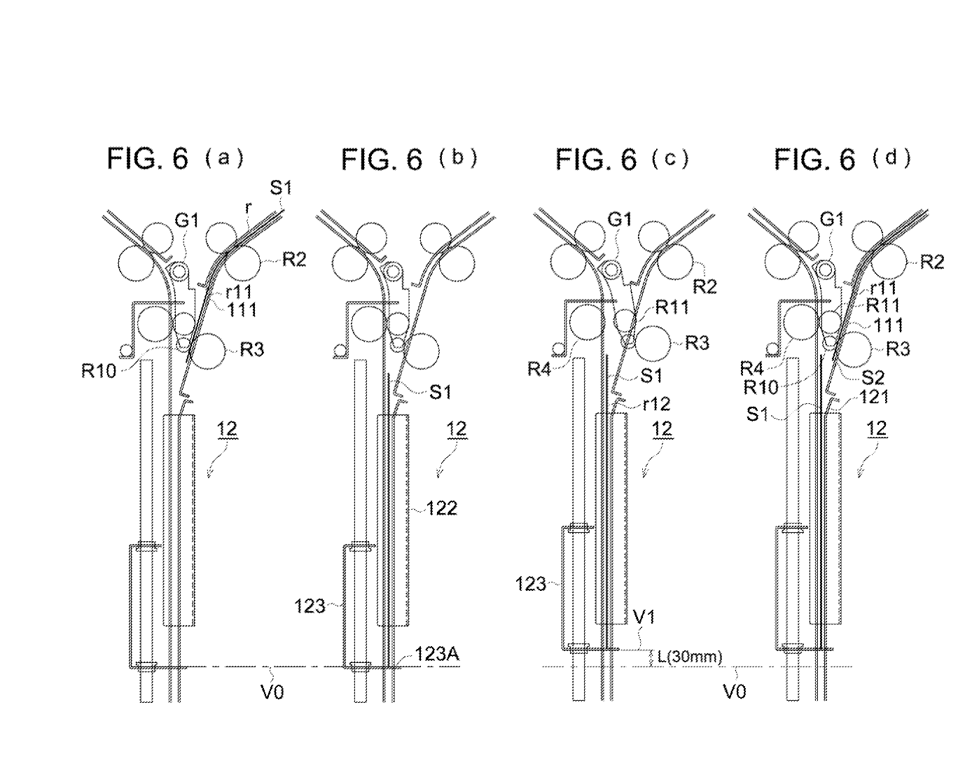

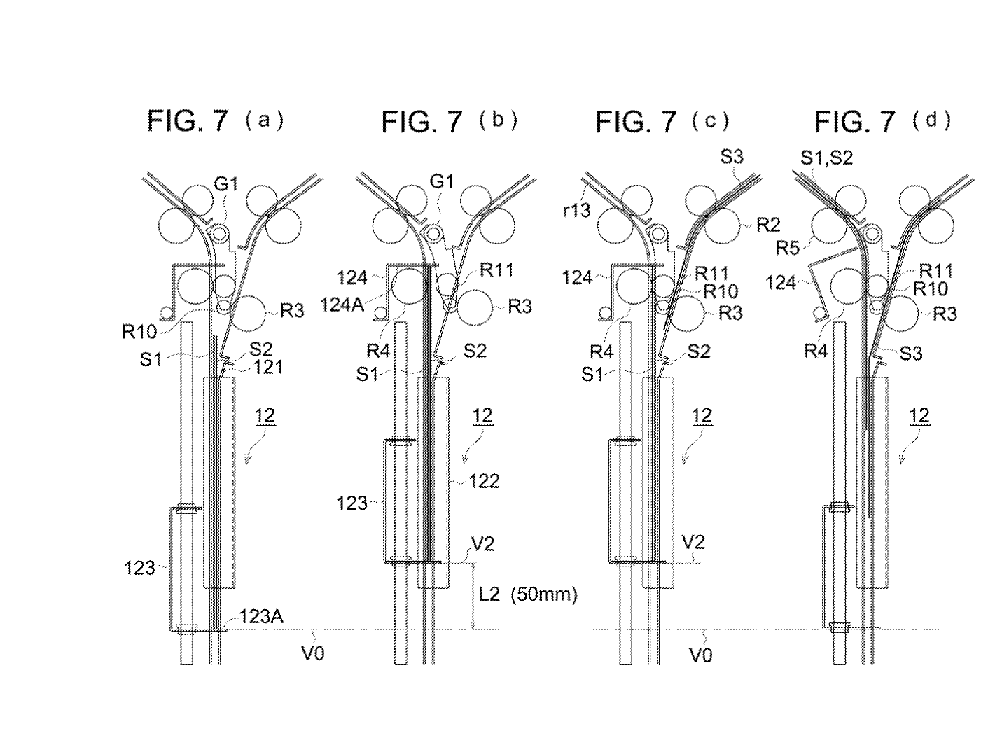

FIG. 5 is a sectional view showing a driving device for a sideward alignment plate 122.

Paired right and left aligning plates 122 are engaged with pins 128A and 125B both fixed on belt 127 that is rotated by motor M4, and they move on a back-and-forth basis in the sideward direction of sheet S to align sheet S in its sideward direction.

Next, operations to superimpose plural sheets in the intermediate conveyance apparatus B will be explained.

Each of FIGS. 6(a)-6(d) and FIGS. 7(a)-7(d) is an illustration showing each process of superimposing plural sheets in the intermediate conveyance apparatus B. In each of FIGS. 6(a)-6(d) and FIGS. 7(a)-7(d), two pieces of sheet are superimposed.

First, as shown in FIG. 6(a), bring-in driven roller R 10 supported rotatably on the tip portion of conveyance path switching section G1 is brought into pressure contact with rotating bring-in drive roller R 3 to be driven to rotate. First sheet S1 that is interposed by rotating conveyance roller R2 to be conveyed is conveyed along guide plate 111 of sheet conveyance path r11. When a leading edge portion of sheet S1 arrives at bring-in drive roller R3, the sheet S1 is interposed by the bring-in drive roller R3 and bring-in drive roller R10 to be conveyed, and advances toward intermediate storing section 12.

The first sheet S1 conveyed to the intermediate storing section 12 hits stopping surface 123A of stopping member 123 as shown in FIG. 6(b) to be stopped.

Next, conveyance path switching section G1 is caused to operate, and take-out driven roller R11 supported rotatably on the intermediate portion of the conveyance path switching section G1 is separated from take-out drive roller R4 as shown in FIG. 6(c). In this case, bring-in drive roller R3 is pressed by bring-in driven roller R10 to swing around conveyance roller R2. After that, the stopping member 123 moves to the first position V1 that is lifted by an unillustrated driving device by prescribed distance L1 (for example, 30 mm) from initial position V0, and stops when the leading edge of sheet S1 arrives at the vicinity of take-out drive roller R4. These operations are needed so that second sheet S2 may be conveyed to the right side in FIG. 6(c).

Then, as shown in FIG. 6(d), conveyance path switching section G1 operates, and bring-in drive roller R3 is restored to its initial position, thus, bring-in drive roller R3 and bring-in driven roller R10 come in contact with each other. Further take-out drive roller R4 and take-out driven roller R11 also come in contact with each other.

Second sheet S2 that is interposed between conveyance rollers R2 to be conveyed is transported along guide plate 111 of sheet conveyance path r11. When a leading edge of the sheet S2 arrives at bring-in drive roller R3, the sheet S2 is interposed between bring-in drive roller R3 and bring-in driven roller R10 to be conveyed, and it advances toward intermediate storing section 12.

When the leading edge of the second sheet S2 has passed through the interposing section between bring-in drive roller R3 and bring-in driven roller R10, stopping member 123 is returned to initial position V0 by a driving device as shown in FIG. 7(a). The leading edge of the second sheet S2 hits stopping surface 123A of stopping member 123 to stop. At this stopping position, the second sheet S2 is superimposed with the first sheet S1.

Next, conveyance path switching section G1 is caused to operate, and take-out driven roller R11 is separated from take-out drive, roller R4 as shown in FIG. 7(b).

After that, the stopping member 123 moves to the second position V2 that is further higher than prescribed distance L1 and is lifted by an unillustrated driving device by prescribed distance L2 (for example, 50 mm) from initial position V0, and superimposed two sheets of sheet S1 and sheet S2 hit stopping surface 124A of longitudinal aligning member 124, and alignment in the conveyance direction is conducted. The stopping position on the upper end portion of the aligned two sheets of sheet S1 and sheet S2 is on the downstream side of the interposing position between take-out drive roller R4 and take-out driven roller D11 in the conveyance direction. Concurrently with or after completion of alignment operations in the conveyance direction, sideward aligning section 122 is driven by an unillustrated driving device, and alignment in the sideward direction is conducted for each of sheet S1 and sheet S2.

Then, the conveyance path switching section G1 is operated as shown in FIG. 7(c), and take-out driven roller R11 is restored to its initial position, thus, superimposed two sheets of sheet S1 and sheet S2 are interposed between take-out drive roller R4 and by take-out driven roller 11.

When a leading edge of the third sheet S3 arrives at bring-in drive roller R3, the sheet S3 is interposed between bring-in drive roller R3 and by bring-in driven roller R10 to be conveyed, and it advances toward intermediate storing section 12.

As shown in FIG. 7(d), longitudinal aligning member 124 is driven by an unillustrated solenoid to retreat from sheet conveyance path r13, and two sheets S1 and S2 interposed between take-out drive roller R4 and take-out driven roller R11 are conveyed under the condition that they are superimposed, and are further interposed between intermediate conveyance rollers R5 to be ejected. Further, substantially at the same time as the ejection of sheet S1 and sheet S2 from the intermediate storing section 12, third sheet S3 interposed between bring-in drive roller R3 and bring-in driven roller R10 advances toward the intermediate storing section 12.

As explained above, in the intermediate conveyance apparatus B in the present embodiment, two sheets S are superimposed, and are conveyed to sheet finisher C under the condition that they are superimposed.

Then, since there is a fixed conveyance distance between the intermediate conveyance apparatus B and the sheet finisher C, a distance for conveying sheets S under the condition that they are superimposed is long.

Even if a distance for conveying superimposed plural sheets S is long, no displacement is caused between sheets, if characteristics such as a size and a type are the same in the superimposed sheets. However, if characteristics such as a size and a type are the different in the superimposed sheets, displacement tends to be caused between sheets when a distance for conveying superimposed plural sheets S is long.

If the displacement is caused undesirably between sheets, alignment between sheets cannot be carried out, resulting in occurrence of troubles in post-processing such as punching processing and binding processing, and a problem of occurrence of paper jam in sheet finisher C is feared.

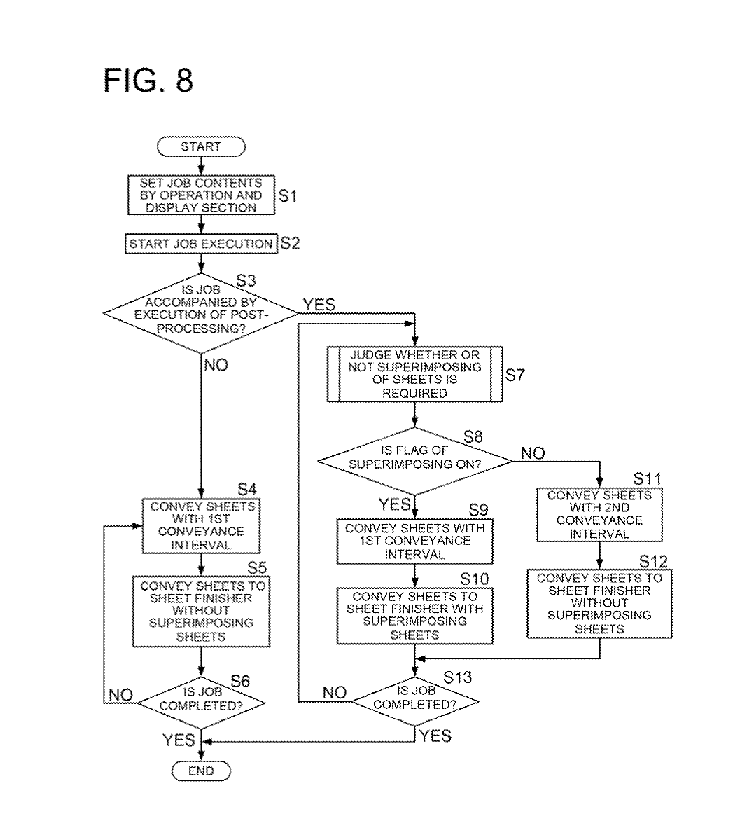

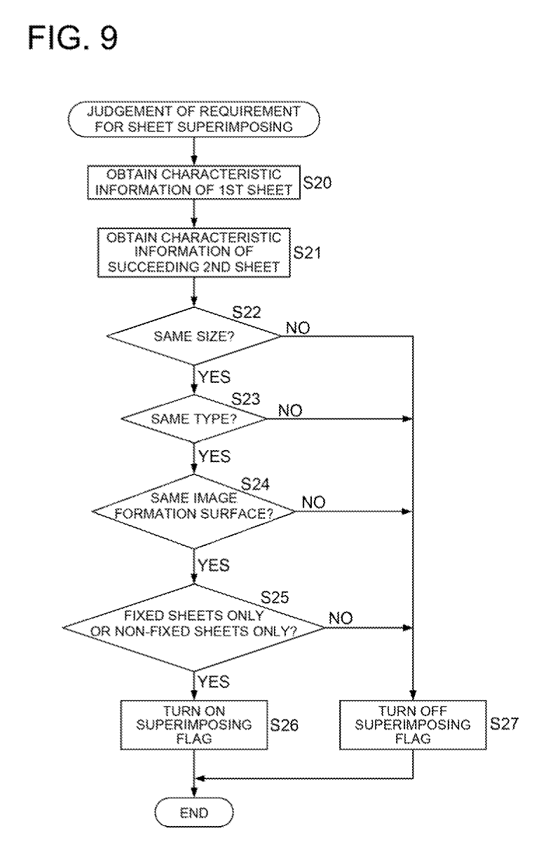

Therefore, properties are compared between sheets conveyed continuously, then, it is judged whether plural sheets S are to be superimposed or not in the intermediate conveyance apparatus B, and operations in the intermediate conveyance apparatus B are switched based on results of the judgment. Concerning this point, a detailed explanation will be given as follows, referring to FIG. 8 and FIG. 9.

FIG. 8 is a flow chart concerning the control of superimposing operations in intermediate conveyance apparatus B and the control of sheet conveyance operations in image forming apparatus A.

First, contents of the job are established by a user in operation and display section A4 of image forming apparatus A (step S1). For example, sheet S to be used for the job is selected, and a type of post-processing in sheet finisher C is selected.

Then, when the job is started in the image forming system (step S2), the job is judged whether it is one that is accompanied by practice of post-processing (punching processing and binding processing) in sheet finisher C or not. This operation is practiced by CPU101 through a prescribed program based on characteristic information of the job in cooperation with ROM 102 and RAM 103. Incidentally, though the operations of step S3 are conducted after practice of the job is started in the present embodiment, operations of step S3 can be conducted before the practice of the job is started, if the contents of the job are decided.

If the job is not accompanied by practice of post-processing in sheet finisher C (step S3; No), it is not necessary to consider a period of time for post-processing in the sheet finisher C, and image forming apparatus A carries out ordinary sheet conveyance operations. In other words, sheet S is conveyed at the first conveyance interval representing an ordinary operations of the image forming apparatus A (step S4), then, is conveyed to sheet, finisher C without being superimposed in intermediate conveyance apparatus B (step S5), and is ejected as it is to movable sheet ejection tray 91 without being subjected to post-processing. Thus, operations of step S4 and of step S5 are repeated until completion of the job (step S6). Incidentally, when no post-processing is practiced in sheet finisher C, sheet S is conveyed to bypass conveyance section 14 in the intermediate conveyance apparatus B.

On the other hand, when the job is accompanied by practice of post-processing in sheet finisher C in step S3 (step S3; Yes), if sheet S is conveyed at the first conveyance interval representing an ordinary specification of image forming apparatus A without superimposing sheets S in the intermediate conveyance apparatus B, there is possibility of occurrence of troubles that sheet S cannot be received in the sheet finisher C. Therefore, it is necessary to practice superimposing operations in the intermediate conveyance apparatus B, and sheet conveyance operations in the image forming apparatus A, by considering a period of time for post-processing in the sheet finisher C, thus, sheet S is judged based on characteristic of sheet S to be conveyed continuously, whether the sheet S is superimposed in the intermediate conveyance apparatus B or not (step S7). Step S7 will be explained in detail, referring to FIG. 9.

FIG. 9 is a flow chart showing judgment operations for whether or not plural sheets S are superimposed in intermediate conveyance apparatus B.

Operations shown in FIG. 9 are practiced by CPU 101 with a prescribed program through cooperation with ROM 102 and RAM 103.

Since two sheets S are superimposed in intermediate conveyance apparatus B in the present embodiment, the judgment is made depending on characteristic information of two sheets to be conveyed continuously in the flow chart shown in FIG. 9.

First, characteristic information of the first sheet (foremost sheet) conveyed through the inside of image forming system is acquired (step S20), and then, characteristic information of the second sheet (sheet succeeding the first sheet) that succeeds the first sheet is acquired (step S21). In the example explained by FIGS. 6(a)-6(d) and FIGS. 7(a)-7(d), characteristic information of sheet S1 and sheet S2 which are superimposed is acquired. Characteristic information for sheets is acquired from characteristic information of a job.

Then, characteristic information of the first sheet is compared with characteristic information of the second sheet, and operations for judgment from step S22 to step S25 are practiced.

In step S22, a size of the first sheet and a size of the second sheet are judged whether they are the same or not. If a sheet size is different between sheets, alignment of sheets in intermediate conveyance apparatus B cannot be conducted properly, and there is possibility of occurrence of troubles in post-processing, thus, a judgment is formed for sizes.

In step S23, a judgment is formed whether a type of the first sheet is the same as that of the second sheet or not. The type of the sheet means characteristics such as a sheet type including a coated paper or a special sheet with a tab, and a basic weight of a sheet. If a sheet type is different between sheets, there is possibility of occurrence of conveyance troubles caused by influence of friction force between sheets, thus, a judgment is formed for sheet types.

In step S24, a judgment is formed whether the image forming surface of the first sheet is the same as that of the second sheet or not. For example, when forming a toner image on the sheet like image forming apparatus A, the direction of sheet curl is different depending on the surface (the surface or the reverse side) of the sheet. If the sheets each having a different curl direction are superimposed, there is possibility of occurrence of displacement between sheets, thus, a judgment is formed about the surface on which the image is formed.

In step S25, the first sheet and the second sheet are judged whether they represent the fixed sheet only or the non-fixed sheet only, or whether they represent the fixed sheet and the non-fixed sheet. The fixed sheet is a sheet which has passed through fixing section 6 of image forming apparatus A, and non-fixed sheet is a sheet which has not passed through a fixing section, such as a cover sheet. When a sheet passes through fixing section 6, heat and pressure are applied on the sheet, thus, the sheet having passed through the fixing section 6 shrinks slightly. Therefore, the fixed sheet and the non-fixed sheet are different slightly each other, even if their basic sizes are the same, and alignment of sheets cannot be carried out properly. Therefore, a judgment is formed about the fixed sheet.

If all judgment operations from step S22 to step S25 are “Yes” (namely, if characteristic information of sheets conveyed continuously agrees with prescribed conditions), a superimposing flag is caused to be ON in control signals because displacement is hardly caused between sheets even when the first sheet and the second sheet are conveyed under the condition that they are superimposed (step S26).

On the other hand, if any one of judgment operations from step S22 to step S25 is “No” (namely, if characteristic information of sheets conveyed continuously does not comply with prescribed conditions), displacement tends to be caused between sheets, if a distance for conveying superimposed plural sheets is caused by different properties of sheets to be long. If the displacement is caused undesirably between sheets, alignment between sheets cannot be carried out, resulting in occurrence of troubles in post-processing such as punching processing and binding processing, and a problem of occurrence of paper jam in the sheet finisher is feared. Therefore, superimposing flag is caused to be OFF in control signals (step S27).

In the explanation by returning also to the flow chart in FIG. 8, a judgment is formed whether superimposing flag is ON or not based on results of superimposing judgment processing in step S7 (step S8).

If the superimposing flag is ON (step S8; Yes) sheet S is conveyed at the first conveyance interval representing an ordinary operation in image forming apparatus A (step S9) because troubles are not caused even when operations to superimpose two sheets are conducted in intermediate conveyance apparatus B, and two sheets are superimposed in the intermediate conveyance apparatus B to be conveyed to sheet finisher C (step S10).

On the other hand, if a superimposing flag is OFF (step S8; No), operations to superimpose sheets are not conducted in the intermediate conveyance apparatus B because displacement tends to occur between sheets and troubles tend to occur if operations to superimpose sheets are conducted in the intermediate conveyance apparatus B. However, if sheets are not superimposed in the intermediate conveyance apparatus B, and if sheet S is conveyed in the image forming apparatus A at the first conveyance interval that is in ordinary use, there is possibility of occurrence of troubles that sheet S cannot be received in the sheet finisher C. Therefore, sheet S is conveyed in the image forming apparatus A at the second conveyance interval that is broader than the first conveyance interval so that a period of time for post-processing may be secured. In other words, if a superimposing flag is not ON, sheet S is conveyed at the second conveyance interval in the image forming apparatus A (step S11), and sheet S is conveyed to sheet finisher C without superimposing sheets S in the intermediate conveyance apparatus B (step S12). In this case, sheet S is controlled to be capable of passing through intermediate storing section 12 in spite of no superimposing operations, for the purpose of aligning sheet surfaces in sheet finisher C.

For the purpose of superimposing two sheets in the intermediate conveyance apparatus B in the present embodiment, processing for judging superimposing is practiced for every two sheets, and operations covering from step S7 to step S12 are repeated until completion of the job (step S13).

Incidentally, switching between the first conveyance interval and the second conveyance interval in image forming apparatus A is practiced by CPU 101 with a prescribed program through cooperation with ROM 102 and RAM 103, based on the results of judgment in step S8.

As explained above, if switching is practiced between superimposing operations in the intermediate conveyance apparatus and sheet conveyance operations in image forming apparatus A, based on characteristic information of sheets to be conveyed continuously, it is possible to prevent troubles in post-processing and sheet conveyance, while taking productivity into consideration.

Further, the invention is not limited to the present embodiment, and a modification and an addition to the embodiment without departing from the spirit and scope of the invention are included in the invention.

Though image forming apparatus A, intermediate conveyance apparatus B and sheet finisher C are connected in the image forming system shown in FIG. 1, the same effect can also be exhibited by an image forming system in a form of one apparatus wherein image forming apparatus A and others, for example, are unified integrally.

Further, though processing for judging superimposing is conducted (step S7) when the job is accompanied by post-processing as shown in FIG. 9 in the present embodiment, it is also possible to conduct processing for judging superimposing for all jobs, and to control image forming apparatus A based on the results of the processing for judging superimposing.

Meanwhile, a condition of judgment for superimposing of sheets in the present embodiment is connected with characteristic information of the first sheet and the second sheet, and it represents an occasion where four conditions for a size, a type, an image formation surface and for no interminglement of a fixed sheet and a non-fixed sheet are satisfied simultaneously. However, the condition of judgment is not limited to these four conditions, but there are further considered other occasions including an occasion that includes also another condition in addition to the aforesaid four conditions, an occasion that includes some conditions out of the aforesaid four conditions and an occasion that includes some conditions out of the aforesaid four conditions and other conditions.

Further, though two sheets S are superimposed in the present embodiment, it is also possible to superimpose three or more sheets S in the embodiment.

The image forming system of the present embodiment makes it possible to prevent troubles for post-processing and sheet conveyance, while taking productivity into consideration.

What is claimed is:

1. An image forming system comprising:
(a) an image forming apparatus which forms an image onto a sheet;
(b) a sheet finisher which conducts a post-processing to the sheet conveyed from the image forming apparatus;
(c) an intermediate conveyance device which is capable of superposing a plurality of sheets conveyed from the image forming apparatus, and conveying the superposed sheets collectively to the sheet finisher; and
(d) a controller which controls a sheet superimposing operation and a sheet conveying operation,
wherein when characteristic information of sheets which are continuously conveyed agrees with a prescribed condition, the controller conveys the sheets at a first conveyance interval in the image forming apparatus, superimposes a plurality of sheets in the intermediate conveyance device, and conveys the superimposed sheets collectively as one set from the intermediate conveyance device to the sheet finisher, and when the characteristic information of sheets which are continuously conveyed does not agree with the prescribed condition, the controller conveys the sheets at a second conveyance interval which is broader than the first conveyance interval in the image forming apparatus, and conveys the sheets from the intermediate device to the sheet finisher without superimposing the sheets in the intermediate device.

2. The image forming system of claim 1, wherein when a job executed in the image forming system is accompanied by execution of the post-processing in the sheet finisher, the controller judges whether or not the characteristic information of the continuously conveyed sheets agrees with the prescribed condition, and controls according to a judged result.

3. The image forming system of claim 1, wherein the prescribed condition is constituted of a plurality of conditions, and at least one condition has a condition in which a size of the continuously conveyed sheets is the same.

4. The image forming system of claim 1, wherein the prescribed condition is constituted of a plurality of conditions, and at least one condition has a condition in which a type of the continuously conveyed sheets is the same.

5. The image forming system of claim 1, wherein the prescribed condition is constituted of a plurality of conditions, and at least one condition has a condition in which each of image formation faces of the continuously conveyed sheets is the same.

6. The image forming system of claim 1, wherein the image forming apparatus comprises a fixing section by which a toner image is fixed on a sheet, and the prescribed condition is constituted of a plurality of conditions, at least one condition has a condition in which a sheet which is passed through the fixing section and a sheet which is not passed through the fixing section are not present in the continuously conveyed sheets.

7. The image forming system of claim 1, wherein the image forming apparatus comprises a fixing section by which a toner image is fixed on a sheet, and the prescribed condition satisfies all of the following conditions:
a size and a type of the continuously conveyed sheets are the same;
each of image formation surfaces of the continuously conveyed sheets is the same; and
a sheet which is passed through the fixing section and a sheet which is not passed through the fixing section are not present simultaneously in the continuously conveyed sheets.
